(19) United States
(12) Patent Application Publication
(10) Pub. No.: US 2022/0049861 A1
(43) Pub. Date: Feb. 17, 2022

(54) HUMIDITY CONTROL SYSTEM

(71) Applicant: SHARP KABUSHIKI KAISHA, Sakai City, Osaka (JP)

(72) Inventors: SHO OCHI, Sakai City, Osaka (JP); TETSUYA IDE, Sakai City, Osaka (JP); HIROKA HAMADA, Sakai City, Osaka (JP); TSUYOSHI KAMADA, Sakai City, Osaka (JP)

(21) Appl. No.: 17/276,070

(22) PCT Filed: Jul. 22, 2019
(86) PCT No.: PCT/JP2019/028638

§ 371 Date: Mar. 12, 2021

(30) Foreign Application Priority Data
Sep. 18, 2018 (JP) 2018-173973

(51) Int. Cl. F24F 3/14; F24F 3/153

(52) U.S. Cl. CPC F24F 3/1417; F24F 2003/1458; F24F 3/153

(57) ABSTRACT

The humidity control system includes: a moisture absorption unit; an atomizing and regenerating unit; and a circulation mechanism that causes a liquid hygroscopic material to circulate between the moisture absorption unit and the atomizing and regenerating unit, in which the atomizing and regenerating unit includes at least one storage tank that stores the liquid hygroscopic material, and an ultrasonic wave generating unit that is provided at the storage tank and emits ultrasonic waves, the ultrasonic wave generating unit forms a liquid column on a liquid surface of a first region, and a flow of the liquid hygroscopic material transported from the moisture absorption unit to the first region in the atomizing and regenerating unit is set in the circulation mechanism to be small relative to a flow of the liquid hygroscopic material supplied from the moisture absorption unit.

### TECHNICAL FIELD

The present invention relates to a humidity control system.

This application claims priority based on Japanese Patent Application No. 2018-173973 filed in Japan on Sep. 18, 2018, the content of which is incorporated herein.

### BACKGROUND ART

Humidity control systems that form a liquid column by exposing a liquid hygroscopic material discharged from a moisture absorption unit to ultrasonic waves and atomize and separate moisture contained in the liquid hygroscopic material to thereby regenerate the liquid hygroscopic material have been conventionally known.

In a humidity control system that uses a liquid column, the higher the liquid temperature of a liquid hygroscopic material in an atomizing and regenerating unit, the greater the atomizing and regenerating efficiency. According to PTL 1, a method of producing concentrated glycerin from an aqueous glycerin solution is disclosed, and water is evaporated by heating the aqueous glycerin solution by using an electric heater.

### CITATION LIST

### Patent Literature

PTL 1: Japanese Unexamined Patent Application Publication No. 2012-144530

### SUMMARY OF INVENTION

### Technical Problem

However, when the liquid temperature of the liquid hygroscopic material of the entire system increases upon external heat input with a heating means such as a heater, the liquid temperature of the liquid hygroscopic material stored in a moisture absorption unit also increases, resulting in a deterioration in hygroscopic capacity.

An aspect of the invention is made in view of the problem of the related art described above and aims to provide a humidity control system capable of improving atomizing efficiency without using an external heat source.

### Solution to Problem

A humidity control system of an aspect of the invention includes: a moisture absorption unit that brings a liquid hygroscopic material containing a hygroscopic substance into contact with air and thereby causes the liquid hygroscopic material to absorb at least some moisture contained in the air; an atomizing and regenerating unit that atomizes at least some moisture contained in the liquid hygroscopic material supplied from the moisture absorption unit, generates atomized droplets, and removes at least some of the atomized droplets from the liquid hygroscopic material to thereby regenerate the liquid hygroscopic material; and liquid hygroscopic material circulation mechanism that causes the liquid hygroscopic material to circulate between the moisture absorption unit and the atomizing and regenerating unit, in which the atomizing and regenerating unit includes at least one storage tank that stores the liquid hygroscopic material, and an ultrasonic wave generating unit that is provided at the storage tank and emits ultrasonic waves for generating the atomized droplets to thereby form a liquid column on a liquid surface of the liquid hygroscopic material in the storage tank, the ultrasonic wave generating unit forms the liquid column on liquid surface of a first region, which extends in a direction perpendicular to an ultrasonic wave generation surface of the ultrasonic wave generating unit, of the liquid hygroscopic material in the storage tank, and a flow of the liquid hygroscopic material transported from the moisture absorption unit to the first region in the atomizing and regenerating unit is set in the circulation mechanism to be small relative to a flow of the liquid hygroscopic material supplied from the moisture absorption unit.

The humidity control system of the aspect of the invention may have a configuration in which the circulation mechanism includes a first channel through which the liquid hygroscopic material regenerated by the atomizing and regenerating unit is transported to the moisture absorption unit, and a second channel through which the liquid hygroscopic material that has absorbed at least some of the moisture contained in the air is transported from the moisture absorption unit to the atomizing and regenerating unit.

The humidity control system of the aspect of the invention may have a configuration in which the circulation mechanism includes a third channel through which some of the liquid hygroscopic material in the second channel is returned to the moisture absorption unit, and the third channel has one end side connected to the second channel and has the other end side connected directly or indirectly to the moisture absorption unit.

The humidity control system of the aspect of the invention may have a configuration in which a temperature of the liquid hygroscopic material in the atomizing and regenerating unit is high relative to a temperature of the liquid hygroscopic material in the moisture absorption unit.

The humidity control system of the aspect of the invention may have a configuration in which the other end side of the third channel is connected to the first channel.

The humidity control system of the aspect of the invention may have a configuration in which the other end side of the third channel is connected to the moisture absorption unit.

The humidity control system of the aspect of the invention may have a configuration in which the atomizing and regenerating unit includes a plurality of storage tanks and ultrasonic wave generating units, the storage tanks each including at least one of the ultrasonic wave generating units, and the liquid hygroscopic material supplied from the moisture absorption unit is supplied to each of the storage tanks.

The humidity control system of the aspect of the invention may be configured to further include a control unit that controls a flow of the liquid hygroscopic material transported from the moisture absorption unit to the atomizing and regenerating unit and may have a configuration in which the control unit reduces a flow ratio of the liquid hygroscopic material transported to the atomizing and regenerating unit when a concentration of the liquid hygroscopic material increases.

The humidity control system of the aspect of the invention may be configured to further include a heat exchange unit that heats the air, which is supplied to the liquid surface of the liquid hygroscopic material atomized by the ultrasonic wave generating unit, by using the liquid hygroscopic material that is supplied from the moisture absorption unit and has a high temperature.

The humidity control, system of the aspect of the invention may have a configuration in which the storage tank includes a heat insulation wall that separates the first region and a second region in which there exists the liquid hygroscopic material whose temperature is low relative to a temperature of the liquid hygroscopic material existing in the first region.

The humidity control system of the aspect of the invention may have a configuration in which the heat insulation wall includes a first communication unit through which the first region and the second region communicate with each other.

The humidity control system of the aspect of the invention may be configured to further include a nozzle which is provided in the first region and is used to form the liquid column by the ultrasonic wave generating unit and in which a through hole is formed.

The humidity control system of the aspect of the invention may have a configuration in which the nozzle has one end side inserted into the heat insulation wall and has the other end side projecting from the heat insulation wall, and the through hole positioned outside the heat insulation wall functions as a second communication unit through which the first region and the second region communicate with each other.

The humidity control system of the aspect of the invention may have a configuration in which the heat insulation wall has a functional membrane including the first communication unit and provided facing the ultrasonic wave generating unit, and the liquid column is formed by the ultrasonic waves being transmitted to the liquid surface via the functional membrane.

### Advantageous Effects of Invention

According to an aspect of the invention, it is possible to provide a humidity control system capable of improving atomizing efficiency without using an external heat source.

### BRIEF DESCRIPTION OF DRAWINGS

FIG. 1 illustrates a schematic configuration of a humidity control system of a first embodiment.

FIG. 2 is a schematic view illustrating a schematic configuration of a humidity control system of a modified example 1.

FIG. 3 is a schematic view illustrating a schematic configuration of a humidity control system of a second embodiment and illustrates an example of control when the concentration of a liquid hygroscopic material is 70%.

FIG. 4 is a schematic view illustrating a schematic configuration of the humidity control system of the second embodiment and illustrates an example of control when the concentration of the liquid hygroscopic material is 90%.

FIG. 5 is a schematic view illustrating a schematic configuration of a humidity control system of a third embodiment.

FIG. 6 is a schematic view illustrating a schematic configuration of a humidity control system of a fourth embodiment.

FIG. 7 is a schematic view illustrating a schematic configuration of an atomizing and regenerating unit in a humidity control system of a fifth embodiment.

FIG. 8 illustrates a modified example of the humidity control system of the fifth embodiment.

FIG. 9 is a schematic view illustrating a schematic configuration of a humidity control system of a sixth embodiment.

FIG. 10 is a schematic view illustrating a schematic configuration of a humidity control system of a seventh embodiment.

FIG. 11 is a schematic view illustrating a schematic configuration of an atomizing system 80.

FIG. 12 is a graph indicating a relationship between atomizing processing time and the temperature of the liquid hygroscopic material existing in each of a first region R1 and a second region R2.

FIG. 13 illustrates a spray method as a moisture absorption method with a liquid hygroscopic material W.

FIG. 14 illustrates a column method as a moisture absorption method with the liquid hygroscopic material W.

### DESCRIPTION OF EMBODIMENTS

A humidity control system according to each embodiment of the invention will be described below.

Note that, in the following drawings, components are drawn at different dimensional scales in some cases for clarity of each of the components.

### First Embodiment

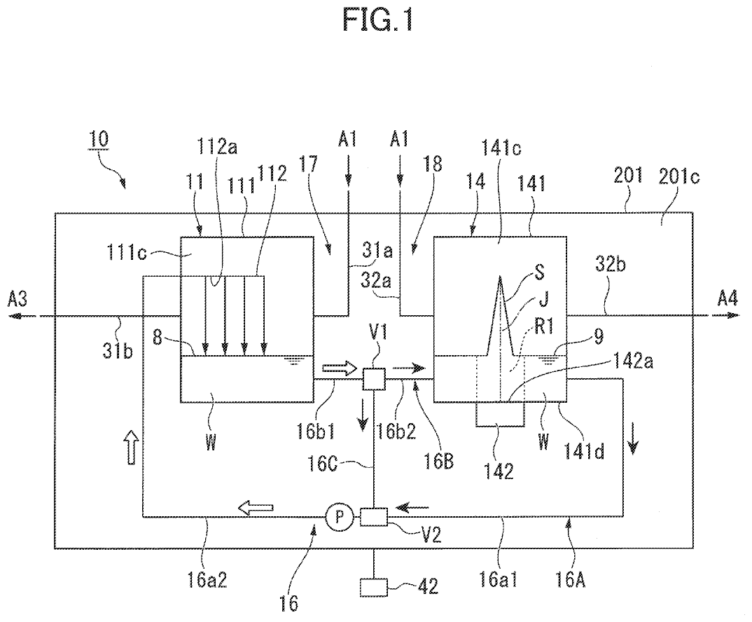

FIG. 1 illustrates a schematic configuration of a humidity control system of a first embodiment.

As illustrated in FIG. 1, a humidity control system 10 of the present; embodiment is a system that brings a liquid hygroscopic material W containing a hygroscopic substance into contact with air, causes the liquid hygroscopic material W to absorb moisture contained in the air, and then separates moisture from the liquid hygroscopic material W which has absorbed the moisture, and thereby regenerates the liquid hygroscopic material W.

The humidity control system 10 includes at least a moisture absorption unit 11, an atomizing and regenerating unit 14, a liquid hygroscopic material circulation mechanism (circulation mechanism) 16, a first air circulation mechanism 17, a second air circulation mechanism 18, and a control unit 42. The humidity control system 10 includes a housing 201, and the moisture absorption unit 11, the atomizing and regenerating unit 14, the liquid hygroscopic material circulation mechanism 16 are housed in an inner space 201c of the housing 201.

In the humidity control system 10 of the present embodiment, the moisture absorption unit 11 brings the liquid hygroscopic material W containing a hygroscopic substance into contact with air A1 existing outside the housing 201 and thereby causes the liquid hygroscopic material W to absorb at least some moisture contained in the air A1. It is sufficient that the moisture absorption unit 11 bring the liquid hygroscopic material W containing the hygroscopic substance into contact with the air A1 and thereby cause the liquid hygroscopic material W to absorb at least some moisture contained in the air A1. The liquid hygroscopic material W will be described later.

The liquid hygroscopic material W that is caused by the moisture absorption unit 11 to contain the moisture is transported from the moisture absorption unit 11 to the atomizing and regenerating unit 14 via the liquid hygroscopic material circulation mechanism 16. The atomizing and regenerating unit 14 atomizes at least some moisture contained in the liquid hygroscopic material W supplied from the moisture absorption unit 11 via the liquid hygroscopic material circulation mechanism 16 and removes at least some moisture from the liquid hygroscopic material W to thereby regenerate the liquid hygroscopic material W. The liquid hygroscopic material W regenerated by the atomizing and regenerating unit 14 is transported to the moisture absorption unit 11 via the liquid hygroscopic material circulation mechanism 16.

In this manner, by the liquid hygroscopic material circulation mechanism 16 circulating the liquid hygroscopic material W between the moisture absorption unit 11 and the atomizing and regenerating unit 14, humidity in an outer space of the housing 201 is controlled.

Components of the humidity control system 10 will be specifically described below.

### Moisture Absorption Unit

The moisture absorption unit 11 includes a moisture absorption storage tank 111 and a liquid hygroscopic material supply unit 112. The liquid hygroscopic material W is stored in an inner space 111c of the moisture absorption storage tank 111. A first transport channel 16A and a second transport channel 16B each of which connects the moisture absorption unit 11 and the atomizing and regenerating unit 14 are connected to the moisture absorption unit 11. Of these, the first transport channel 16A is provided so as to be connected to an upper portion of the moisture absorption storage tank 111 at a position higher than a liquid surface 8 of the liquid hygroscopic material W stored in the inner space 111c. The second transport channel 16B is provided so as to be connected to a lower portion of the moisture absorption storage tank 111 at a position lower than the liquid surface 8 of the liquid hygroscopic material W stored in the inner space 111c.

The liquid hygroscopic material supply unit 112 is arranged in an upper portion of the inner space 111c of the moisture absorption storage tank 111 and is connected to the first transport channel 16A. The liquid hygroscopic material supply unit 112 has many supply holes 112a through which the liquid hygroscopic material W, which is returned to the moisture absorption unit 11 via the first transport channel 16A, flows downward in the inner space 111c of the moisture absorption storage tank 111.

### First Air Circulation Mechanism

The first air circulation mechanism 17 includes a first air supply channel 31a, a first air discharge channel 31b, and a blower not illustrated and circulates air for the moisture absorption unit 11.

The first air supply channel 31a is a channel for supplying the air A1 in the outer space of the housing 201 to the inner space 111c of the moisture absorption storage tank 111. The first air discharge channel 31b is a channel for discharging the air in the inner space 111c of the moisture absorption storage tank 111 to the outside of the housing 201.

The blower is arranged in the middle of the first air supply channel 31a. The blower supplies the air A1 from the outer space of the housing 201 to the inner space 111c of the moisture absorption storage tank 111 via the first air supply channel 31a and generates an air flow for supplying dried air A3 from the inner space 111c of the moisture absorption storage tank 111 to the outer space of the housing 201 via the first air discharge channel 31b.

Note that, although the air A1 is introduced from the first air supply channel 31a and the dried air A3 is discharged from the first air discharge channel 31b to the outside in the present embodiment, the air introduction path and the air discharge path may be interchanged. That is, the air A1 may be introduced from the first air discharge channel 31b, and the air A3 may be discharged from the second air supply channel 32a.

### Atomizing and Regenerating Unit

The atomizing and regenerating unit 14 includes a regeneration storage tank 141 and an ultrasonic vibrator (ultrasonic wave generating unit) 142.

The regeneration storage tank 141 is connected to the moisture absorption storage tank 111 via the second transport channel 16B and stores, in an inner space 141c, the liquid hygroscopic material W transported from the moisture absorption storage tank 111.

The ultrasonic vibrator 142 emits ultrasonic waves for generating a liquid column S. Although one ultrasonic vibrator 142 is provided in the present embodiment, the number of ultrasonic vibrators 142 may be changed accordingly.

When the liquid hygroscopic material W stored in the regeneration storage tank 141 is exposed to ultrasonic waves, the liquid column S is formed on a liquid surface 9 of the liquid hygroscopic material W, moisture is separated from the surface of the liquid column S, and atomized droplets are generated. When the ultrasonic vibrator 142 exposes the liquid hygroscopic material W to ultrasonic waves, by adjusting conditions (such as output and frequency) for generating the ultrasonic waves, the liquid column S of the liquid hygroscopic material W, which has a given height, is able to be generated on the liquid surface 9 of the liquid hygroscopic material W.

(Addition) The ultrasonic vibrator 142 is preferably provided to be inclined with respect to a bottom surface 141d of the regeneration storage tank 141. An axis extending from the center of an ultrasonic wave exposure surface 142a of the ultrasonic vibrator 142 so as to be perpendicular to the ultrasonic wave exposure surface 142a is defined as a radiation axis J of the ultrasonic waves. When the ultrasonic vibrator 142 is inclined with respect to the bottom surface 141d of the regeneration storage tank 141, the ultrasonic waves are propagated from the ultrasonic wave exposure surface 142a to the liquid surface 9 such that the radiation axis J is inclined with respect to the liquid surface 9 of the liquid hygroscopic material W. This makes it difficult for ultrasonic waves reflected by the liquid surface 9 to return to the ultrasonic vibrator 142, and the ultrasonic vibrator 142 is less likely to be damaged by the ultrasonic waves. Further, it is possible to prevent atomization from being inhibited due to liquid being separated from a tip end of the liquid column S and flowing downward to the liquid column S.

As illustrated in FIG. 1, of the liquid hygroscopic material W stored in the regeneration storage tank 141, an ultrasonic wave propagation region surrounded by a virtual plane extending from a periphery of the ultrasonic wave exposure surface 142a of the ultrasonic vibrator 142 in the direction perpendicular to the ultrasonic wave exposure surface 142a is referred to as “a first region R1” in the embodiment of the invention. For example, when the ultrasonic wave exposure surface 142a is circular, the ultrasonic wave propagation region that has a columnar shape extending from the periphery of the ultrasonic wave exposure surface 142a in the direction perpendicular to the ultrasonic wave exposure surface 142a is “the first region R1”.

### Second Air Circulation Mechanism

The second air circulation mechanism 18 includes a second air supply channel 32a, a second air discharge channel 32b, and a blower not illustrated and circulates air for the atomizing and regenerating unit 14.

The second air supply channel 32a is a channel for supplying the air A1 in the outer space of the housing 201 to the inner space of the regeneration storage tank 141. The second air discharge channel 32b is an air for discharging the air in the inner space of the regeneration storage tank 141 to the outside of the housing 201.

The blower is arranged in the middle of the second air supply channel 32a. The blower supplies the air A1 from the outer space of the housing 201 to the inner space of the regeneration storage tank 141 via the second air supply channel 32a and generates an air flow for supplying air A4, which is humidified due to containing moisture, from the inner space of the regeneration storage tank 141 to the outer space of the housing 201 via the second air discharge channel 32b.

Note that, although the air A1 is introduced from the second air supply channel 32a and the air A4 is discharged from the second air discharge channel 32b to the outside in the present embodiment, the air introduction path and the air discharge path may be interchanged. That is, the air A1 may be introduced from the second air discharge channel 32b, and the air A4 may be discharged from the second air supply channel 32a.

### Liquid Hygroscopic Material Circulation Mechanism

The liquid hygroscopic material circulation mechanism 16 includes the first transport channel (first channel) 16A, the second transport channel (second channel) 16B, a third transport channel (third channel) 16C, a first valve V1, a second valve V2, and a pump P and constitutes a channel for circulating the liquid hygroscopic material W between the moisture absorption unit 11 and the atomizing and regenerating unit 14.

The first transport channel 16A is a channel for transporting, to the moisture absorption unit 11, the liquid hygroscopic material W regenerated by the atomizing and regenerating unit 14. The first transport channel 16A has one end side connected to the atomizing and regenerating unit 14 and has the other end side connected to the moisture absorption unit 11.

The second transport channel 16B is a channel for transporting, from the moisture absorption unit 11 to the atomizing and regenerating unit 14, the liquid hygroscopic material W that has absorbed, in the moisture absorption unit 11, at least some moisture contained in the air. The second transport channel 16B has one end side connected to the moisture absorption unit 11 and has the other end side connected to the atomizing and regenerating unit 14.

The third transport channel 16C is a channel for returning some of the liquid hygroscopic material W in the second transport channel 16B to the moisture absorption unit 11 and connects the second transport channel 16B and the first transport channel 16A. The third transport channel 16C has one end side connected to the second transport channel 16B and has the other end side connected to the first transport channel 16A. The third transport channel 16C is connected indirectly to the moisture absorption unit 11 via the first transport channel 16A.

The first valve V1 is arranged at least in the middle of the second transport channel 16B. Specifically, the first valve V1 is arranged in a portion in which the third transport channel 16C is connected to the second transport channel 16B. The first valve V1 is a three-way valve of a division type, which divides the flow of a fluid from one direction into two directions, and has a single inlet port and two outlet ports (a first outlet port and a second outlet port). The first valve V1 divides a flow of the liquid hygroscopic material W, which flows from the single inlet port;, into two directions and enables the liquid hygroscopic material W to flow out from the first outlet port and the second outlet port.

Specifically, a connection channel 16b1 of the second transport channel 16B is connected to the inlet port of the first valve V1. A connection channel 16b2 leading to the atomizing and regenerating unit 14 is connected to the first outlet port of the first valve V1. The third transport channel 16C is connected to the second outlet port.

The second valve V2 is arranged at least in the middle of the first transport channel 16A. Specifically, the second valve V2 is arranged in a portion in which the third transport channel 16C is connected to the first transport channel 16A. The second valve V2 is a three-way valve of a mixing type, which mixes fluids transported in two directions, and has two inlet ports (a first inlet port and a second inlet port) and a single outlet port. The second valve V2 mixes flows of the liquid hygroscopic material W flowing from two inlet ports and enables the mixed liquid hygroscopic material W to flow out from the outlet port.

A connection channel 16a1 of the first transport channel 16A is connected to the first inlet port of the second valve V2. A channel of the third transport channel 16C is connected to the second inlet port of the second valve V2. The pump P is connected to the outlet port of the second valve V2.

The pump P supplies, to the moisture absorption unit 11, the liquid hygroscopic material W mixed by the second valve V2.

The control unit 42 controls operation of the pump P to circulate the liquid hygroscopic material W existing in a circulation path. Moreover, the control unit 42 divides the flow in accordance with any division ratio, which is set in advance, for the first valve V1.

### Liquid Hygroscopic Material

The liquid hygroscopic material W is a liquid that exhibits a property (hygroscopicity) of absorbing moisture and is preferably, for example, a liquid that exhibits hygroscopicity at a temperature of 25° C. and a relative humidity of 50% and under atmospheric conditions. The liquid hygroscopic material W contains a hygroscopic substance described later. The liquid hygroscopic material W may contain a hygroscopic substance and a solvent. As the solvent, a solvent that dissolves the hygroscopic substance or that is mixable with the hygroscopic substance is used, and examples thereof include water. The hygroscopic substance may be an organic material or an inorganic material.

Examples of the organic material used as the hygroscopic substance include a dihydric or higher alcohol, a ketone, an organic solvent having an amide group, a saccharide, and a known material used as a raw material for moisturizing cosmetics etc. Of these, from the viewpoint of high hydrophilicity, the dihydric or higher alcohol, the organic solvent having the amide group, the saccharide, or the known material used as the raw material for moisturizing cosmetics etc. is preferable as the organic material used as the hygroscopic substance.

Examples of the dihydric or higher alcohol include glycerin, propanediol, butanediol, pentanediol, trimethylolpropane, butanetriol, ethylene glycol, diethylene glycol, and triethylene glycol.

Examples of the organic solvent having the amide group include formamide and acetamide.

Examples of the saccharide include sucrose, pullulan, glucose, xylol, fructose, mannitol, and sorbitol.

Examples of the known material used as the raw material for moisturizing cosmetics etc. include 2-methacryloyloxyethyl phosphorylcholine (MPC), betaine, hyaluronic acid, and collagen.

Examples of the inorganic material used as the hygroscopic substance include calcium chloride, lithium chloride, magnesium chloride, potassium chloride, sodium chloride, zinc chloride, aluminum chloride, lithium bromide, calcium bromide, potassium bromide, sodium hydroxide, and sodium pyrrolidone carboxylate.

In a case where the hydrophilicity of the hygroscopic substance is high, when, for example, a material of the hygroscopic substance is mixed with water, water molecules that are adsorbed exist in the vicinity of a surface (liquid surface) of the liquid hygroscopic material W in a high proportion. The atomizing and regenerating unit 14 described later generates atomized droplets in the vicinity of the surface of the liquid hygroscopic material W serving as the liquid column S and separates moisture from the liquid hygroscopic material W. Thus, when the proportion of the water molecules that are adsorbed in the vicinity of the surface of the liquid hygroscopic material W is high, the moisture is able to be efficiently separated, which is preferable. Moreover, the hygroscopic substance exists in the vicinity of the surface of the liquid hygroscopic material W in a relatively low proportion, and therefore, loss of the hygroscopic substance in the atomizing and regenerating unit 14 is suppressed, which is preferable.

Of the liquid hygroscopic material W, the concentration of the hygroscopic substance contained in the liquid hygroscopic material W used for processing in the moisture absorption unit 11 is not particularly limited but is preferably 40 mass % or more. When the concentration of the hygroscopic substance is 40 mass % or more, the liquid hygroscopic material W is able to efficiently absorb moisture.

The viscosity of the liquid hygroscopic material W is preferably 25 mPa·s or less. Thereby, the liquid column S of the liquid hygroscopic material W is easily generated on the liquid surface 9 of the liquid hygroscopic material W in the atomizing and regenerating unit 14 described later. Thus, it is possible to efficiently separate moisture from the liquid hygroscopic material W.

### Effect of Humidity Control System

In the humidity control system 10 of the present embodiment, the control unit 42 drives the pump P to enable the liquid hygroscopic material W to flow downward from the liquid hygroscopic material supply unit 112 provided in the moisture absorption storage tank 111. Simultaneously, the control unit 42 drives the blower of the second air circulation mechanism 18 to thereby supply the air A1 in the outer space of the housing 201 to the moisture absorption storage tank 111 via the first air supply channel 31a and form an air flow directed to the first air discharge channel 31b.

When the air flowing in the moisture absorption storage tank 111 is in contact with the liquid hygroscopic material W flowing downward from each supply hole 112a of the liquid hygroscopic material supply unit 112, the moisture in the air A1 is absorbed by the liquid hygroscopic material W and removed. The control unit 42 drives the blower to thereby discharge the dehumidified air A3 to the outer space of the housing 201 via the first air discharge channel 31b. The control unit 42 also drives the pump P to thereby enable the liquid hygroscopic material W stored in the moisture absorption storage tank 111 to flow out to the second transport channel 16B.

In the present embodiment, the first valve V1 arranged in the second transport channel 16B divides the flow of the liquid hygroscopic material W, which flows in the second transport channel 16B, into two directions in accordance with any division ratio set in advance.

When the division ratio for the first valve V1 is, for example, 1:1, half of the flow of the liquid hygroscopic material W flowing out from the moisture absorption unit 11 is supplied to the atomizing and regenerating unit 14, and the other half of the flow is caused to flow out to the third transport channel 16C.

Note that the division ratio for the first valve V1 is not limited to the aforementioned ratio and may be changed accordingly. When the ratio of the flow to the atomizing and regenerating unit 14 decreases, atomization temperature increases, but when the ratio of the flow decreases excessively, replacement of the liquid hygroscopic material W stored in the regeneration storage tank 141 slows down, and thus, the concentration of the liquid hygroscopic material W stored in the regeneration storage tank 141 increases excessively. Accordingly, a balance between the liquid temperature and the concentration of the liquid hygroscopic material W is important.

In the atomizing and regenerating unit 14, when the control unit 42 drives the ultrasonic vibrator 142, the liquid hygroscopic material W stored in the regeneration storage tank 141 is exposed to ultrasonic waves to form the liquid column S, and the liquid hygroscopic material W containing moisture is pushed up. At this time, of the liquid hygroscopic material W stored in the regeneration storage tank 141, “the first region R1” overlapping the ultrasonic vibrator 142 in plan view is exposed to the ultrasonic waves in a concentrated manner. The liquid column 5 is formed on a liquid surface of “the first region R1”. The liquid column S overlaps the ultrasonic vibrator 142 in plan view in the direction of the radiation axis J.

When the flow of the liquid hygroscopic material W flowing out to the atomizing and regenerating unit 14 through the first valve V1 is reduced, the flow rate at which the liquid hygroscopic material W flows to the regeneration storage tank 141 decreases, and thus, the liquid surface of “the first region R1” is able to be smoothly retained, and the liquid column S is satisfactorily formed.

By driving the blower of the second air circulation mechanism 18, the control unit 42 supplies the air A1 in the outer space to the regeneration storage tank 141 via the second air supply channel 32a and forms an air flow directed to the second air discharge channel 32b. When the air A1 flowing in the regeneration storage tank 141 is brought into contact with the liquid column S formed by the ultrasonic vibrator 142, atomized droplets are generated. In this manner, by separating moisture from the liquid hygroscopic material W containing moisture, the liquid hygroscopic material W is regenerated. The atomized droplets separated from the liquid column S are absorbed by the air A1. By driving the blower, the control unit 42 discharges the air A4, which is humidified due to containing the atomized droplets, to the outer space of the housing 201 via the second air discharge channel 32b.

In the present embodiment, the circulation channel is configured such that the flow of the liquid hygroscopic material W is divided while being transported from the moisture absorption unit 11 to the atomizing and regenerating unit 14 and such that the flow of the liquid hygroscopic material W supplied to the regeneration storage tank 141 is small relative to the flow of the liquid hygroscopic material W flowing out from the moisture absorption unit 11. Thus, the flew of the liquid hygroscopic material W supplied to “the first region R1” to be exposed to the ultrasonic waves in a concentrated manner by the ultrasonic vibrator 142 is reduced. As a result, the liquid hygroscopic material W stored in the regeneration storage tank 141 is more easily affected by heat input from the ultrasonic vibrator 142, the liquid temperature thereof increases, and the liquid hygroscopic material W forms the liquid column S when reaching a high temperature. Temperature T2 of the liquid hygroscopic material W in the regeneration storage tank 141 increases relative to temperature T1 of the liquid hygroscopic material W in the moisture absorption storage tank 111. When the liquid temperature of the liquid hygroscopic material W increases, a greater number of atomized droplets are generated to form the liquid column S.

The control unit 42 drives the pump P to thereby transport the liquid hygroscopic material W regenerated by the atomizing and regenerating unit 14 to the moisture absorption unit 11 through the first transport channel 16A. Since the third transport channel 16C is connected to the first transport channel 16A via the second valve V2, some of the liquid hygroscopic material W, which is transported through the third transport channel 16C, and the liquid hygroscopic material W regenerated by the atomizing and regenerating unit 14 are mixed by the second valve V2. The mixed liquid hygroscopic material W is transported to the moisture absorption unit 11 through a connection channel 16a2 of the first transport channel 16A.

Here, the liquid temperature of the liquid hygroscopic material W transported through the third transport channel 16C is low relative to the liquid temperature of the liquid hygroscopic material W transported from the atomizing and regenerating unit 14 through the first transport channel 16A.

Here, when the temperature of the liquid hygroscopic material W stored in the moisture absorption storage tank 111 is T1, the temperature of the liquid hygroscopic material W stored in the regeneration storage tank 141 is T2, and the temperature of the mixed liquid hygroscopic material W is T3, the temperatures satisfy a relation of T1<T3<T2. Note that temperature T2 is the temperature of the liquid hygroscopic material W existing in the first region R1, to which a great quantity of heat is input by the ultrasonic vibrator 142, of the liquid hygroscopic material W stored in the regeneration storage tank 141.

In the humidity control system 10 of the present embodiment, the liquid hygroscopic material circulation mechanism 16 sets the flow of the liquid hygroscopic material W transported from the moisture absorption unit 11 to the atomizing and regenerating unit 14 to be small relative to the flow of the liquid hygroscopic material W flowing out from the moisture absorption unit 11 and thereby reduces the amount of the liquid hygroscopic material W supplied to the atomizing and regenerating unit 14 compared with a conventional system. When the flow of the liquid hygroscopic material W supplied to the atomizing and regenerating unit 14 is reduced, the liquid temperature of the liquid hygroscopic material W stored in the regeneration storage tank 141 increases upon heat input from the ultrasonic vibrator 142. That is, since a supply amount of the liquid hygroscopic material W supplied to the regeneration storage tank 141 is small, it takes time for all the liquid hygroscopic material W stored in the regeneration storage tank 141 to be replaced, and heat input from the ultrasonic vibrator 142 continues during the replacement, resulting in a great increase in the liquid temperature of the liquid hygroscopic material W stored in the regeneration storage tank 141.

In this manner, when a circulation amount of the liquid hygroscopic material W (a replacement velocity of the liquid hygroscopic material W) in the regeneration storage tank 141 is set to be small relative to a circulation amount of the liquid hygroscopic material W in the entire circulation path, a rate of increase in liquid temperature due to heat input from the ultrasonic vibrator 142 increases, and it is possible to increase temperature 72 of the liquid hygroscopic material W stored in the regeneration storage tank 141.

When it is assumed that the liquid temperature of the liquid hygroscopic material W in the entire circulation system increases in response to external heat input by a heater or the like, the liquid temperature in the moisture absorption storage tank 111 also increases, resulting in a deterioration in hygroscopic performance.

Therefore, the present embodiment provides a system in which the liquid temperature of the liquid hygroscopic material W is increased by using heat input from the ultrasonic vibrator 142.

Moreover, since the liquid hygroscopic material W that is discharged from the atomizing and regenerating unit 14 to the first transport channel 16A and that has a high temperature is mixed with the liquid hygroscopic material W that is in the third transport channel 16C and that has a low temperature, temperature T3 of the mixed liquid hygroscopic material W to be returned to the moisture absorption unit 11 is lower than temperature T2 of the liquid hygroscopic material W discharged from the atomizing and regenerating unit 14. Thus, the liquid hygroscopic material W that has a high temperature is not supplied to the moisture absorption unit 11, and it is possible to suppress a deterioration in hygroscopic performance of the moisture absorption unit 11.

In this manner, by reducing the flow of the liquid hygroscopic material W to be supplied to the atomizing and regenerating unit 14, it is possible to increase the liquid temperature of only the liquid hygroscopic material W stored in the regeneration storage tank 141 without increasing a heat amount of each tank in the entire circulation system. Thereby, it is possible to improve atomizing efficiency of the liquid hygroscopic material W in the atomizing and regenerating unit 14 while keeping hygroscopic performance of the moisture absorption unit 11 and to enhance regeneration performance of the liquid hygroscopic material W in the atomizing and regenerating unit 14. Since the ultrasonic vibrator 142 having an existing configuration is used without using an external heat source, it is possible to suppress cost for heating.

Note that, although the liquid hygroscopic material W the flow of which is divided at a given flow ratio by the first valve V1 is supplied to the atomizing and regenerating unit 14 at all times in the present embodiment, the liquid hygroscopic material W may be supplied to the atomizing and regenerating unit 14 in a time-division manner. That is, the time to supply the liquid hygroscopic material W to the atomizing and regenerating unit 14 may be divided such that a given flow of liquid hygroscopic material W is supplied. In this case, the flow ratio is set to be appropriate for a product flow of the liquid hygroscopic material W.

Moreover, by reducing the flow of the liquid hygroscopic material W to be supplied to the atomizing and regenerating unit 14, the temperature of the liquid hygroscopic material W is able to be made higher upon heat input from the ultrasonic vibrator 142 compared with a conventional system, and thus, it is expected to improve a microbicidal effect with respect to the liquid hygroscopic material W. This makes it possible to reduce a risk of generating fungi and viruses.

In the present embodiment, a flow-down system in which the liquid hygroscopic material W flows downward from an upper portion of the moisture absorption storage tank 111 to be in contact with the air A1 is adopted as a moisture absorption method of the moisture absorption unit 11 with use of the liquid hygroscopic material W, but there is no limitation thereto.

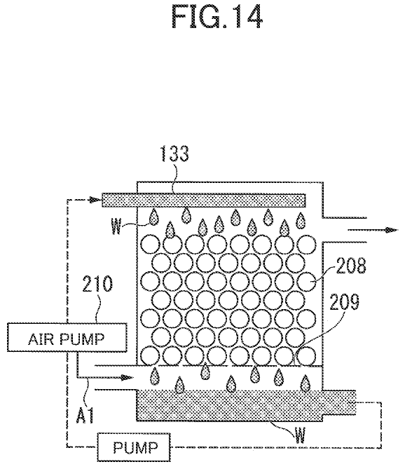

For example, a spray system in which the liquid hygroscopic material W in an atomized state is sprayed in an air flow of the air A1 generated by a blower 202 as illustrated in FIG. 13 may be used. A humidity control system adopting the spray system includes, for example, a pump 203 that feeds the liquid hygroscopic material W stored in the moisture absorption storage tank 111, a pipe 204 in which the liquid hygroscopic material W fed by the pump 203 flows, and a spray nozzle 205 provided in one end of the pipe 204. The spray nozzle 205 is positioned above the liquid surface of the liquid hygroscopic material W stored in the moisture absorption storage tank 111.

Moreover, a column system in which a column is impregnated with the liquid hygroscopic material W in an air flow of the air A1 generated by an air pump 210 as illustrated in FIG. 14 may be used. In a humidity control system adopting the column system, for example, the moisture absorption storage tank 111 includes a plurality of filling materials 208, a support plate 209 that supports the filling materials 208, the air pump 210 that feeds outside air A1, and a nozzle unit 133.

### Modified Example of First Embodiment

Next, a humidity control system 12 as a modified example of the first embodiment will be described.

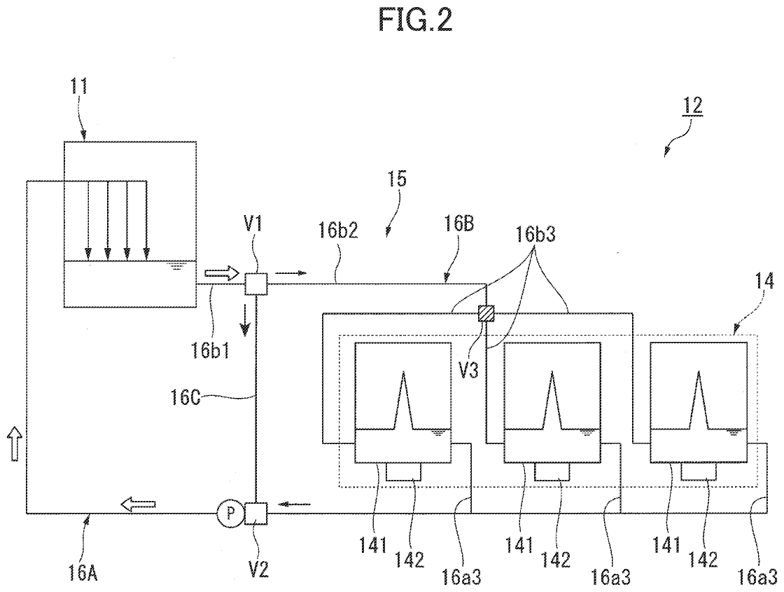

FIG. 2 is a schematic view illustrating a schematic configuration of the humidify control system 12 of a modified example 1.

As illustrated in FIG. 2, the humidity control system 12 of the modified example 1 is a system which includes a plurality of regeneration storage tanks (storage tanks) 141 and in which the liquid hygroscopic material W transported from the moisture absorption unit 11 is supplied to the respective regeneration storage tanks 141 dividedly. Each of the regeneration storage tanks 141 is provided with at least one ultrasonic vibrator 142, and atomizing processing is performed by each ultrasonic vibrator 142.

The atomizing and regenerating unit 14 in the present example is connected to the moisture absorption unit 11 via a liquid hygroscopic material, circulation mechanism (circulation mechanism) 15 capable of dividedly supplying, to the respective regeneration storage tanks 141, the liquid hygroscopic material W discharged from the moisture absorption unit 11.

Note that, for example, three regeneration storage tanks 141 are provided in the modified example 1, but the number of regeneration storage tanks 141 is not limited thereto.

The liquid hygroscopic material circulation mechanism 15 includes the first transport channel 16A, the second transport channel 16B, and the third transport channel 16C.

The second transport channel 16B through which the liquid hygroscopic material W discharged from the moisture absorption unit 11 is transported to the atomizing and regenerating unit 14 has the connection channels 16b1 and 16b2 and a plurality of branch channels 16b3, and the first valve V1 and a third valve V3 are arranged in the middle of the second transport channel 16B. The number of branch channels 16b3 is set in accordance with the number of regeneration storage tanks 141, and three branch channels 16b3 are provided here.

As described above, the first valve V1 is arranged in a portion in which the third transport channel 16C is connected to the second transport channel 16B. The third valve V3 is arranged on the downstream side of the first valve V1 and in a branch point of the channels. The “downstream side” means a side closer than the first valve V1 to the atomizing and regenerating unit 14 in a direction in which the liquid hygroscopic material W flows in the second transport channel 16B.

The third valve V3 is a four-way valve of a division type, which divides a flow from one direction to three directions, and has a single inlet port and three outlet ports (a first outlet port, a second outlet port, and a third outlet port). The third valve V3 divides the flow of the liquid hygroscopic material W, which flows from the connection channel 16b2 connected to the inlet port, in accordance with a division ratio set in advance and enables the liquid hygroscopic material W to flow out from the respective branch channels 16b3 connected to the first outlet port, the second outlet port, and the third outlet port. In the present example, for example, the liquid hygroscopic material W discharged from the moisture absorption unit 11 is equally divided by the third valve V3, and the liquid hygroscopic material W is equally supplied to the three regeneration storage tanks 141.

The first transport channel 16A has at least the connection channels 16a1 and 16a2 and a plurality of branch channels 16a3. In the present example, the branch channels 16a3 connected to the respective regeneration storage tanks 141 are connected to the connection channel 16a1.

In such a humidity control system 12, the first valve V1 divides the flow of the liquid hygroscopic material W, which is discharged from the moisture absorption unit 11, at a division ratio of, for example, 3:7 such that the flow of the liquid hygroscopic material W flowing out to the atomizing and regenerating unit 14 is small. Then, the third valve V3 divides the flow at a division ratio of, for example, 1:1:1 such that the flows of the liquid hygroscopic material W supplied to the respective regeneration storage tanks 141 via the respective branch channels 16b3 are equal.

When the atomizing and regenerating unit 14 includes the plurality of regeneration storage tanks 141 and the liquid hygroscopic material W discharged from the moisture absorption unit 11 is dividedly supplied to the respective regeneration storage tanks 141 as in the present example, the flow of the liquid hygroscopic material W supplied to one regeneration storage tank 141 is reduced, and it is possible to efficiently increase the liquid temperature of the liquid hygroscopic material W stored in each of the regeneration storage tanks 141. This makes it possible to improve atomizing efficiency of the atomizing and regenerating unit 14.

Next, moisture absorption systems of a second embodiment to a fourth embodiment will be described. In the following description, description for a portion common to that in the moisture absorption system of the first embodiment, will be omitted, and the point different from that of the embodiment will be specifically described. In the drawings used for the description, components common to those in FIG. 1 will be given the same reference numerals. Further, illustration of the housing 201 and the control unit 42 will be omitted except for FIG. 1.

### Second Embodiment

Next, a humidity control system 20 of the second embodiment of the invention will be described.

The following humidity control system 20 of the present embodiment is almost similar to that of the first embodiment in the basic configuration except that a concentration sensor 21 and a variable flow valve V4 are provided.

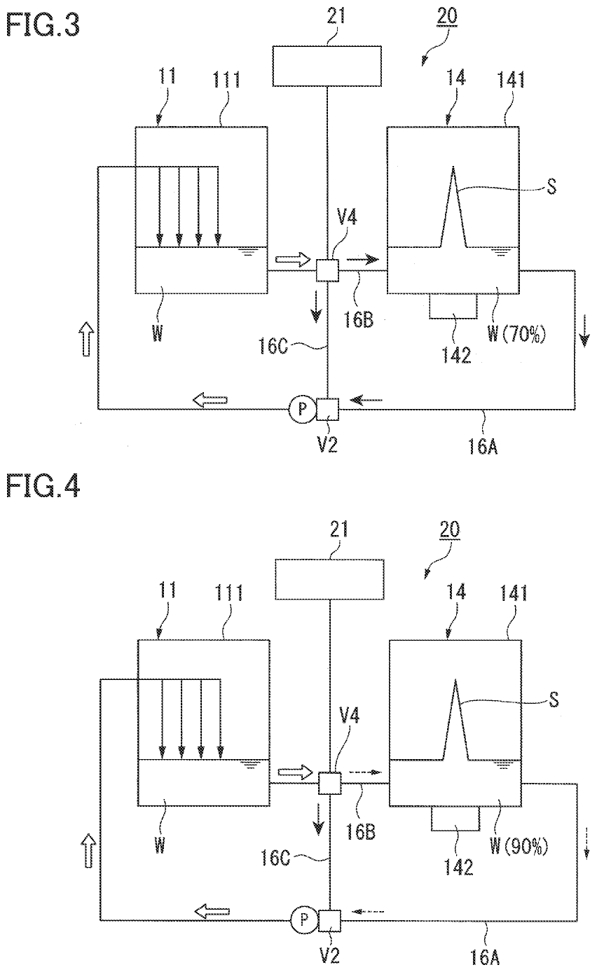

FIG. 3 is a schematic view illustrating a schematic configuration of the humidity control system 20 of the second embodiment and illustrates an example of control when the concentration of the liquid hygroscopic material W is 70%.

FIG. 4 is a schematic view illustrating a schematic configuration of the humidity control system 20 of the second embedment and illustrates an example of control when the concentration of the liquid hygroscopic material W is 90%.

As illustrated in FIGS. 3 and 4, in the humidity control system 20 of the present embodiment, the concentration sensor 21 and the variable flow valve V4 are arranged in a portion in which the second transport channel 16B and the third transport channel 16C are connected.

The concentration sensor 21 measures the concentration of the liquid hygroscopic material W discharged from the moisture absorption unit 11 and performs feedback to the control unit 42 (FIG. 1).

The variable flow valve V4 is a valve capable of varying, in accordance with conditions, a division ratio of the liquid hygroscopic material W the flow of which in the second transport channel 16B is divided to the second transport channel 16B and the third transport channel 16C.

In such a humidity control system 20, the division ratio of the liquid hygroscopic material W the flow of which is divided by the variable flow valve V4 is adjusted in accordance with the concentration measurement result fed back from the concentration sensor 21 to the control unit 42 (FIG. 1), and a given amount of the liquid hygroscopic material W is supplied to the atomizing and regenerating unit 14. In the present embodiment, when the concentration of the liquid hygroscopic material W increases, the control unit 42 (FIG. 1) reduces the flow ratio of the liquid hygroscopic material W transported to the atomizing and regenerating unit 14.

For example, as illustrated in FIG. 3, when the concentration of the liquid hygroscopic material W is 70%, the division ratio for the variable flow valve V4 is adjusted to, for example, 1:1, and a half of the flow of the liquid hygroscopic material W discharged from the moisture absorption unit 11 is supplied to the atomizing and regenerating unit 14, and the other half of the flow is returned to the moisture absorption unit 11 via the third transport channel 16C.

Moreover, as illustrated in FIG. 4, when the concentration of the liquid hygroscopic material W increases to 90%, the division ratio for the variable flow valve V4 is adjusted to, for example, 1:4 to reduce the flow of the liquid hygroscopic material W supplied to the atomizing and regenerating unit 14.

When the concentration of the liquid hygroscopic material W supplied to the atomizing and regenerating unit 14 increases, atomizing efficiency is lowered. Thus, the temperature of the liquid hygroscopic material W stored in the regeneration storage tank 141 needs to be made higher. When the flow of the liquid hygroscopic material W supplied to the regeneration storage tank 141 is reduced, a ratio of heat input from the ultrasonic vibrator 142 increases, and it is possible to efficiently increase the liquid temperature. Thereby, even when the concentration of the liquid hygroscopic material W is high, it is possible to improve atomizing efficiency of the atomizing and regenerating unit 14.

### Third Embodiment

Next, a humidity control system 30 of the third embodiment of the invention will be described.

The following humidity control system 30 of the present embodiment is almost similar to that of the first embodiment in the basic configuration except that a heat exchange unit 33 is provided.

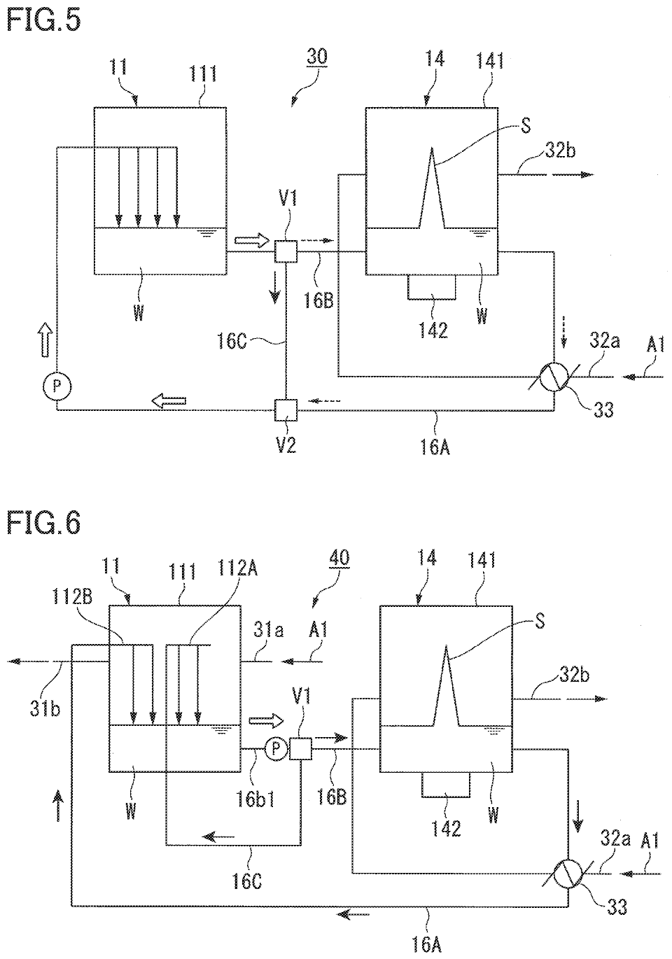

FIG. 5 is a schematic view illustrating a schematic configuration of the humidity control system 30 of the third embodiment.

The humidity control, system 30 of the present embodiment includes the heat exchange unit 33 in a portion in which the first transport channel 16A and the second air supply channel 32a cross.

The heat exchange unit 33 is, for example, a fin-tube heat exchanger. By using the liquid hygroscopic material W that is discharged from the atomizing and regenerating unit 14 and has a high temperature, the heat exchange unit 33 is able to increase the temperature of the air A1 in the outer space to be supplied to the atomizing and regenerating unit 14.

As described in the foregoing example, although atomizing efficiency of the atomizing and regenerating unit 14 is improved when the liquid temperature of the liquid hygroscopic material W increases, hygroscopic performance of the moisture absorption unit 11 is deteriorated when the liquid temperature of the liquid hygroscopic material W increases. Since the temperature of the liquid hygroscopic material W discharged from the atomizing and regenerating unit 14 increases upon heat input from the ultrasonic vibrator 142, the liquid hygroscopic material W needs to be reduced in liquid temperature before being returned to the moisture absorption unit 11. Although the liquid temperature of the liquid hygroscopic material W to be returned to the moisture absorption unit 11 is able to be reduced to some extent by mixing the liquid hygroscopic material W that is in the first transport channel 16A and has a high temperature and the liquid hygroscopic material W that is in the third transport channel 16C and is not heated, the liquid temperature is able to be further reduced by using the heat exchange unit 33 in the present embodiment.

In the present embodiment, by providing the heat exchange unit 33 in a portion in which the first transport channel 16A connected to the atomizing and regenerating unit 14 is connected to the second air supply channel 32a connected to the atomizing and regenerating unit 14, it is possible to efficiently perform heat exchange between the liquid hygroscopic material W that is discharged from the atomizing and regenerating unit 14 and has a high temperature and the air A1 taken from the outer space. Thereby, the air A1 supplied to the atomizing and regenerating unit 14 is heated by the liquid hygroscopic material W.

When the surface of the liquid column S formed in the regeneration storage tank 141 is exposed to the air A1, the surface temperature of the liquid column S increases, and atomization is promoted. In this manner, in the present embodiment, it is possible to further improve atomizing efficiency of the atomizing and regenerating unit 14.

Moreover, since the liquid temperature of the liquid hygroscopic material W to be returned to the moisture absorption unit 11 is able to be further reduced, it is possible to improve hygroscopic performance of the moisture absorption unit 11.

Further, in the present embodiment, the division ratio for the first valve V1 is set to, for example, 1:9. Thereby, of the flow of the liquid hygroscopic material W discharged from the moisture absorption unit 11, the flow of the liquid hygroscopic material W supplied to the atomizing and regenerating unit 14 is considerably reduced. Thus, compared to a case where the flow is divided at the division ratio of 1:1, replacement of the liquid hygroscopic material W stored in the atomizing and regenerating unit 14 becomes much slower, and the liquid temperature of the liquid hygroscopic material W increases more efficiently upon heat input from the ultrasonic vibrator 142. As a result, atomizing efficiency of the atomizing and regenerating unit 14 is improved.

Moreover, it is possible to efficiently heat the air A1 by using the liquid hygroscopic material W that is discharged from the atomizing and regenerating unit 14 and has a high temperature. Further, when the liquid hygroscopic material W after heat exchange and the liquid hygroscopic material W the flow of which is large relative to that of the liquid hygroscopic material W after heat exchange are mixed by the second valve V2, the liquid temperature of the liquid hygroscopic material W to be returned to the moisture absorption unit 11 is able to be made close to the liquid temperature of the liquid hygroscopic material W stored in the moisture absorption unit 11. As a result, it is possible to keep hygroscopic performance of the moisture absorption unit 11.

### Fourth embodiment

Next, a humidity control system 40 of the fourth embodiment of the invention will be described.

The following humidity control system 40 of the present embodiment is almost similar to that of the third embodiment in the basic configuration except that the other end side of the third transport channel 16C is directly connected to the moisture absorption unit 11.

FIG. 6 is a schematic view illustrating a schematic configuration of the humidity control system 40 of the fourth embodiment.

In the humidity control system 40 of the present embodiment, the liquid hygroscopic material W that is discharged from the atomizing and regenerating unit 14 and is in the first transport channel 16A and the liquid hygroscopic material W that is in the third transport channel 16C are not mixed but are each returned to the moisture absorption unit 11 separately.

In the present embodiment, the pump P and the first valve V1 are arranged in the middle of the second transport channel 16B. For example, the pump P is arranged in the middle of the connection channel 16b1 of the second transport channel 16B and arranged on the upstream side (moisture absorption unit 11 side) of the first valve V1.

The first valve V1 divides the flow of the liquid hygroscopic material W, which is discharged from the moisture absorption unit 11 by the pump P and is in the second transport channel 16B, at a division ratio of, for example, 1:1, and enables a half of the flow to flow out to the third transport channel 16C.

In the moisture absorption unit 11, a first liquid hygroscopic material supply unit 112A and a second liquid hygroscopic material supply unit 112B are provided in the moisture absorption storage tank 111.

The third transport channel 16C of the present embodiment has one end side connected to the second transport channel 16B via the first valve V1 and has the other end side directly connected to the first liquid hygroscopic material supply unit 112A of the moisture absorption unit 11. Thus, it is possible to return the liquid hygroscopic material W, which is discharged from the moisture absorption unit 11, to the moisture absorption unit 11 without changing the liquid temperature thereof.

The first transport channel 16A has one end side connected to the atomizing and regenerating unit 14 and has the other end side connected to the second liquid hygroscopic material supply unit 112B of the moisture absorption unit 11. The heat exchange unit 33 is arranged in the middle of the first transport channel 16A, and by performing heat exchange between the liquid hygroscopic material W discharged from the atomizing and regenerating unit 14 and the air A1 that is introduced from the outside and has a normal temperature, the liquid temperature of the liquid hygroscopic material W to be returned to the moisture absorption unit 11 is reduced.

In the humidity control system 40 of the present embodiment, the liquid hygroscopic material W that does not pass through the atomizing and regenerating unit 14 is returned to the moisture absorption unit 11 with priority to be in contact with the air A1 supplied to the moisture absorption unit 11. That is, the air A1 supplied through the first air supply channel 31a to the moisture absorption storage tank 111 is in contact with the liquid hygroscopic material W, which is supplied from the first liquid hygroscopic material supply unit 112A and has low concentration, and is dehumidified to some extent, and then, the air A1 is further in contact with the liquid hygroscopic material W, which is supplied from the second liquid hygroscopic material supply unit 112B and has high concentration, and is further dehumidified. Thereby, moisture absorption efficiency of the moisture absorption unit 11 is improved, and it is possible to keep a certain difference or more in vapor pressure at all times.

Next, humidity control systems of a fifth embodiment to a seventh embodiment will be described. In the following description, description for a portion common to that in the first embodiment will be omitted, and the point different from that of the embodiment will be specifically described. In the drawings used for the description, components common to those in FIG. 1 will be given the same reference numerals. Further, since components other than the atomizing and regenerating unit 14 are similar to those of the first embodiment, illustration thereof will be omitted.

### Fifth Embodiment

Next, a humidity control system 50 of the fifth embodiment of the invention will be described.

The following humidity control system 50 of the present embodiment is almost similar to that of the first embodiment in the basic configuration except that a heat insulation wall 145 is provided in the regeneration storage tank 141.

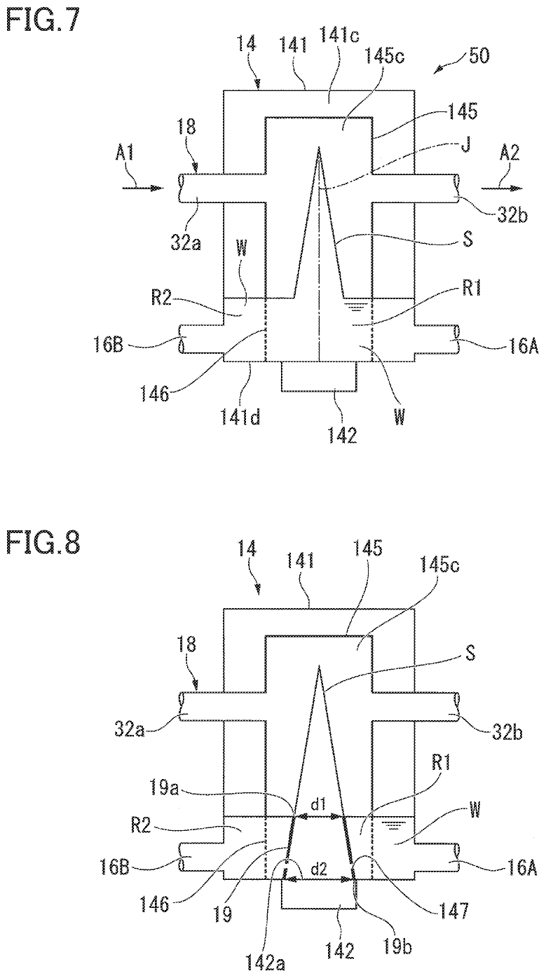

FIG. 7 is a schematic view illustrating a schematic configuration of the atomizing and regenerating unit 14 in the humidity control system 50 of the fifth embodiment.

The atomizing and regenerating unit 14 in the humidity control system 50 of the present embodiment has the heat insulation wall 145 in the inner space 141c of the regeneration storage tank 141.

The heat insulation wall 145 has a cylindrical shape and is provided on the bottom surface 141d of the regeneration storage tank 141. The heat insulation wall 145 separates the interior of the regeneration storage tank 141 into two regions. The first region R1 surrounded by the heat insulation wall 145 is a region overlapping the ultrasonic vibrator 142 in plan view in the direction extending along the radiation axis J of the ultrasonic vibrator 142. The liquid hygroscopic material W existing in the first region R1 is exposed to ultrasonic waves in a concentrated manner by the ultrasonic vibrator 142 and thus has temperature which is high relative to the liquid temperature of the liquid hygroscopic material W existing in the second region R2.

The liquid hygroscopic material W supplied from the moisture absorption unit 11 exists in the second region R2 around the heat insulation wall 145 and has temperature which is low relative to that of the liquid hygroscopic material W existing in the first region R1.

The heat insulation wall 145 has a first communication unit 146 through which the first region R1 and the second region R2 communicate with each other. The first communication unit 146 is formed by a through hole passing through a peripheral wall in the thickness direction. At least one first communication unit 146 is provided on the bottom side of the heat insulation wall 145, and a plurality of first communication units 146 may be provided.

Note that the first communication unit 146 is not limited to being formed by simply providing a through hole, but may be formed by providing an osmosis membrane, non-woven cloth, or the like, which is permeable to moisture, so as to cover the through hole. A material having a liquid-permeating property corresponding to the liquid hygroscopic material W stored in the atomizing and regenerating unit 14 may be selected such that the circulation amount between the first region R1 and the second region R2 is appropriate.

The second air supply channel 32a and the second air discharge channel 32b of the second air circulation mechanism 18 are connected to the heat insulation wall 145. The air A1, which is in the outer space and is supplied via the second air supply channel 32a, is directly supplied to an inner space 145c of the heat insulation wall 145. On the other hand, the humidified air A4 in the inner space 145c of the heat insulation wall 145 is directly discharged to the outer space via the second air discharge channel 32b.

According to the humidity control system 50 of the present embodiment, by providing the heat insulation wall 145 in the regeneration storage tank 141, it is possible to efficiently increase the temperature of the liquid hygroscopic material W existing in the first region R1 upon heat input from the ultrasonic vibrator 142. Since the liquid hygroscopic material W is circulated between the first region R1 and the second region R2 via the first communication unit 146 provided in the heat insulation wall 145, the amount of the circulation is small.

Thus, replacement of the liquid hygroscopic material W existing in the first region R1 becomes slow, and it is possible to efficiently increase the liquid temperature of the liquid hygroscopic material W existing in the first region R1 upon heat input from the ultrasonic vibrator 142. This makes it possible to improve atomizing efficiency of the atomizing and regenerating unit 14.

Note that the number of heat insulation walls 145 provided in the regeneration storage tank 141 is not limited to one. For example, a plurality of heat insulation walls 145 may be provided in accordance with the number of ultrasonic vibrators 142. By providing the heat insulation wall 145 for each of the ultrasonic vibrators 142, it is possible to efficiently increase the liquid temperature of the liquid hygroscopic material W stored in the regeneration storage tank 141, thus making it possible to improve atomizing efficiency of the entire atomizing and regenerating unit 14.

### Modified Example of Fifth Embodiment

FIG. 8 illustrates a modified example of the humidity control system 50 of the fifth embodiment.

As illustrated in FIG. 8, in the present example, a nozzle 19 for forming the liquid column S by the ultrasonic vibrator 142 is provided in the inner space 145c of the heat insulation wall 145 arranged in the regeneration storage tank 141, that is, the first region R1 surrounded by the heat insulation wall 145.

The nozzle 19 has a conical shape in which diameter d1 of an opening 19a on one end side and diameter d2 of an opening 19b on the other end side satisfy a relation of d1<d2.

At least one second communication unit 147 is provided in the nozzle 19. The second communication unit 147 is formed by a through hole passing through a peripheral wall of the nozzle 19. The liquid hygroscopic material W stored in the heat insulation wall 145 is circulated between regions inside and outside the nozzle 19 through the second communication unit 147. The nozzle 19 is provided on the bottom surface 141d of the regeneration storage tank 141 and is provided at a position overlapping the ultrasonic wave exposure surface 142a of the ultrasonic vibrator 142 in plan view in the direction of the radiation axis J.

Note that it is preferable that the nozzle 19 be temporarily detachable from the regeneration storage tank 141. This makes it possible to clean the nozzle 19 and facilitate maintenance.

In the present example, by further providing the nozzle 19 in the inside of the heat insulation wall 145, it is possible to efficiently eject the liquid hygroscopic material W existing in the first region R1 and further increase the height of the liquid column S. As a result, it is possible to further improve atomizing efficiency of the atomizing and regenerating unit 14.

### Sixth Embodiment

Next, a humidity control system 60 of the sixth embodiment of the invention will be described.

The following humidity control system 60 of the present embodiment is almost similar to that of the modified example of the fifth embodiment in the basic configuration except that the inner space 145c of the heat insulation wall 145 is separated by the nozzle 19. Thus, in the following description, the point different from that of the modified example of the fifth embodiment will be specifically described, and description for a common portion will be omitted. Moreover, in the drawings used for the description, components common to those in FIGS. 7 and 8 will be given the same reference numerals.

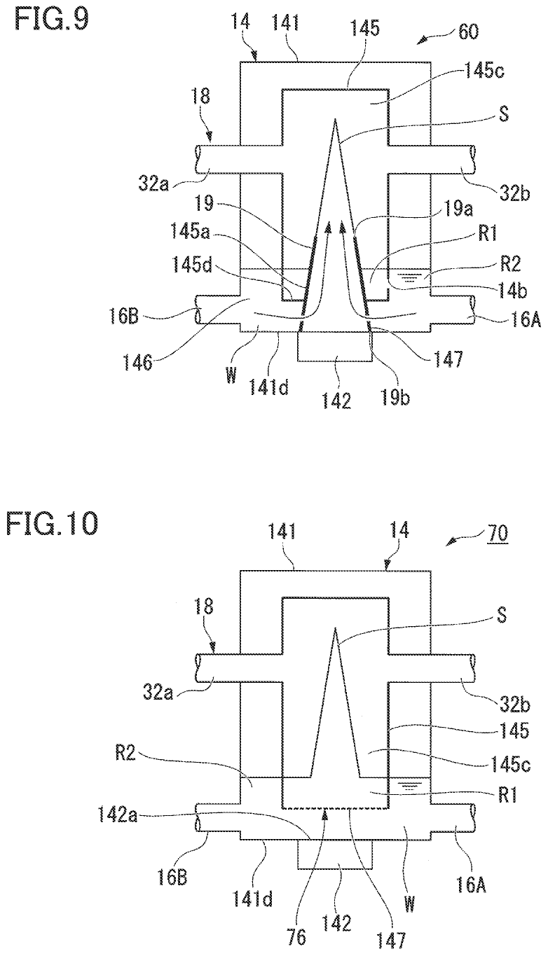

FIG. 9 is a schematic view illustrating a schematic configuration of the humidity control system 60 of the sixth embodiment.

In the humidity control system 60 of the present embodiment, the heat insulation wall 145 arranged in the regeneration storage tank 141 is provided in a state of being floated from the bottom surface 141d of the regeneration storage tank 141. The nozzle 19 is arranged in a through hole 145a formed on a bottom surface 145d of the heat insulation wall 145. The nozzle 19 is provided such that openings 19a and 19b are parallel to the bottom surface 141d of the regeneration storage tank 141. The nozzle 19 is provided in a state where one end side is inserted to the inside of the heat insulation wall 145 and the other end side is projected from the bottom surface 145d of the heat insulation wall 145 toward the bottom surface 141d of the regeneration storage tank 141. At least one second communication unit 147 is formed on the other end side of the nozzle 19. The second communication unit 147 enables the first region R1 that is separated by the heat insulation wall 145 and the nozzle 19 and the second region R2 that is outside the heat insulation wall 145 and the nozzle 19 to communicate with each other.

In the modified example of the fifth embodiment described above, not only the liquid hygroscopic material W that reaches a high temperature by being exposed to ultrasonic waves but also the liquid hygroscopic material W that is discharged from the moisture absorption unit 11 and flows into the second region R2 through the first communication unit 146 of the heat insulation wall 145 exist in the first region R1 surrounded by the heat insulation wall 145.

In the humidity control system 60 of the present embodiment, the liquid hygroscopic material W supplied to the regeneration storage tank 141 through the second transport channel 16B always passes through the second communication unit 147 of the nozzle 19 to flow into the nozzle 19 and is exposed to ultrasonic waves by the ultrasonic vibrator 142, and thereby, the liquid hygroscopic material W is ejected from the opening of the nozzle 19 on the other end side, and the liquid column S is formed in the heat insulation wall 145. Therefore, only the liquid hygroscopic material W that reaches a high temperature by receiving heat input from the ultrasonic vibrator 142 is stored in the first region R1 surrounded by the heat insulation wall 145.

In the present embodiment, the first communication unit 146 that enables the liquid hygroscopic material W in the heat insulation wall 145 to flow out to the outside of the heat insulation wall 145 is preferably formed in a portion of a peripheral wall on the first transport channel 16A side of peripheral walls of the heat insulation wall 145.

In the present embodiment, the liquid hygroscopic material W discharged from the moisture absorption unit 11 does not directly flow into the inner space 145c of the heat insulation wall 145, and the liquid hygroscopic material W that always passes through the nozzle 19 is stored in the inner space 145c of the heat insulation wall 145 and is separated. Thus, it is possible to efficiently increase the temperature of the liquid hygroscopic material W.

### Seventh Embodiment

Next, a humidity control system 70 of the seventh embodiment of the invention will be described.

The following humidity control system 70 of the present embodiment is almost similar to that of the sixth embodiment in the basic configuration except that a functional membrane 76 is provided in the heat insulation wall 145. Thus, in the following description, the point different from the foregoing embodiments will be specifically described, and description for a common portion will be omitted. Moreover, in the drawings used for the description, components common to those in FIG. 9 will be given the same reference numerals.

FIG. 10 is a schematic view illustrating a schematic configuration of the humidity control system 70 of the seventh embodiment.

The humidity control system 70 of the present embodiment includes the regeneration storage tank 141, the heat insulation wall 145 provided in a state of being floated from the bottom surface 141d of the regeneration storage tank 141, and the second air circulation mechanism 18. The functional membrane 76 constituting the bottom surface is provided in the heat insulation wall 145.

The functional membrane 76 is provided to face the ultrasonic wave exposure surface 142a of the ultrasonic vibrator 142 and to be parallel to the ultrasonic wave exposure surface 142a. The functional membrane 76 has the second communication unit 147 through which the first region R1 separated by the heat insulation wall 145 and the second region R2 outside the heat insulation wall 145 communicate with each other.

Examples of the functional membrane 76 include a porous membrane, a forward osmosis membrane, and a reverse osmosis membrane. When the functional membrane 76 is formed by a porous membrane, many pores function as the second communication unit 147. When the functional membrane 76 is formed by an osmosis membrane or non-woven cloth, a gap between fibers that constitute the osmosis membrane or non-woven cloth functions as the second communication unit 147.

In the humidity control system 70 of the present embodiment, the liquid hygroscopic material W in the first region R1 separated by the heat insulation wall 145 is exposed to ultrasonic waves via the functional membrane 76, and the ultrasonic waves are transmitted to the liquid surface to thereby form the liquid column S.

The functional membrane 76 is not limited to the materials described above and may be, for example, a membrane which is selectively permeable to only moisture. This makes it possible to supply a lot of moisture to the heat insulation wall 145 and reduce the concentration of the liquid hygroscopic material W stored in the first region R1. With the reduction in the concentration of the liquid hygroscopic material W, the liquid temperature of the liquid hygroscopic material W readily increases upon heat input with ultrasonic waves, and it is possible to improve atomizing efficiency of the atomizing and regenerating unit 14.

### Experiment 1

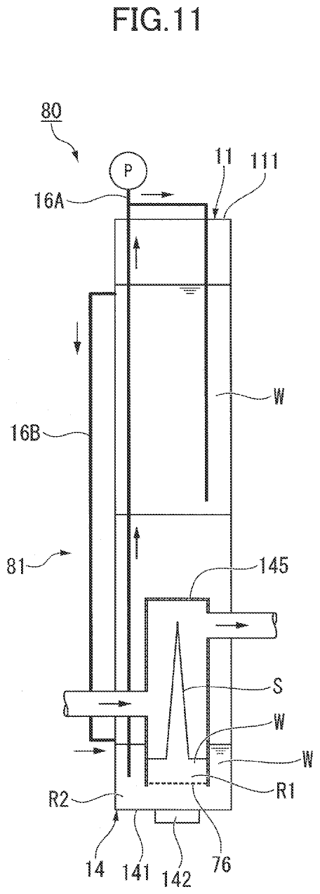

FIG. 11 is a schematic view illustrating a schematic configuration of an atomizing system 80.

The present inventors conducted an experiment to measure the temperature of the liquid hygroscopic material W existing in the first region R1 separated by the heat insulation wall 145 and the temperature of the liquid hygroscopic material W existing in the second region R2 by using the atomizing system 80 including the atomizing and regenerating unit 14 having the heat insulation wall 145.

The atomizing system 80 used for the experiment is a system in which the atomizing and regenerating unit 14 and the moisture absorption unit 11 are stacked in the up-down direction, which includes a liquid hygroscopic material circulation mechanism 81 performing transportation of the liquid hygroscopic material W between the atomizing and regenerating unit 14 and the moisture absorption unit 11, and which performs only atomizing processing. The atomizing and regenerating unit 14 has a configuration which is almost similar to the configuration of the seventh embodiment described above and in which the bottom surface of the heat insulation wall 145 arranged in the regeneration storage tank 141 while being floated is constituted by the functional membrane 76. As the functional membrane 76, a cellophane membrane in which about ten micropores having a diameter of about 1 mm were formed was used.

The liquid hygroscopic material circulation mechanism 81 includes the first transport channel 16A that has one end side inserted into the regeneration storage tank 141 and has the other end side inserted into the moisture absorption storage tank 111, the pump P that is arranged in the middle of the first transport channel 16A, and the second transport channel 16B that has one end side connected to the moisture absorption storage tank 111 and has the other end side connected to the regeneration storage tank 141. The one end side of the first transport channel 16A is positioned outside the heat insulation wall 145 provided in the regeneration storage tank 141 and is immersed in the liquid hygroscopic material W existing in the second region R2.

In the atomizing system 80, the liquid hygroscopic material W existing in the first region R1 separated by the heat insulation wall 145 is exposed to ultrasonic waves by the ultrasonic vibrator 142 via the functional membrane 76 of the heat insulation wall 145 to thereby form the liquid column S, and atomizing processing is performed. Simultaneously, the pump P is driven to transport the liquid hygroscopic material W existing in the second region R2 of the regeneration storage tank 141 to the moisture absorption storage tank 111 via the first transport channel 16A. When reaching a certain storage amount, the liquid hygroscopic material W stored in the moisture absorption storage tank 111 is transported to the regeneration storage tank 141 through the second transport channel 16B. In the atomizing system 80, the liquid hygroscopic material W in the moisture absorption unit 11 positioned on the upper side is spontaneously supplied to the atomizing and regenerating unit 14 positioned on the lower side by using potential energy thereof.

During the atomizing processing, the temperature of the liquid hygroscopic material W existing in each of the first region R1 and the second region R2 in the atomizing and regenerating unit 14 was measured by using a temperature sensor.

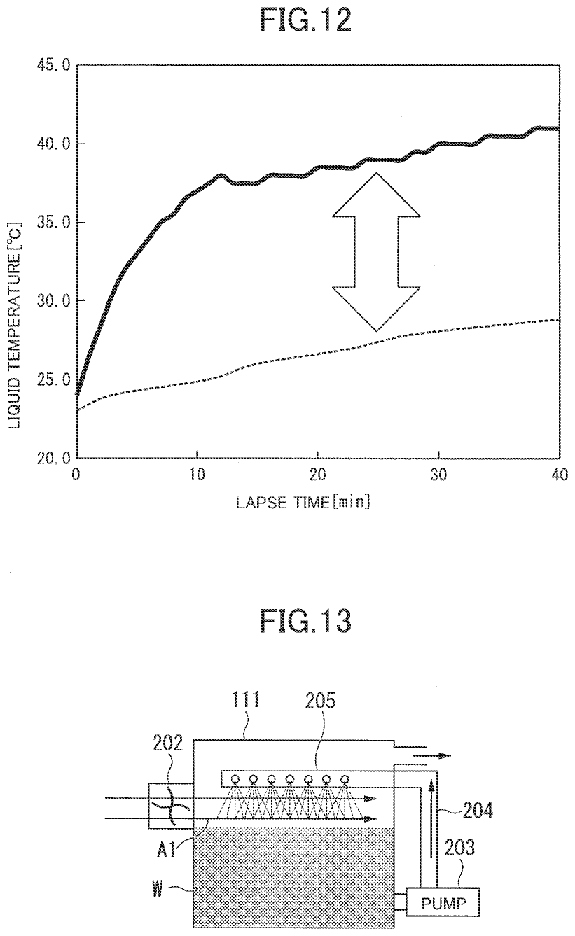

FIG. 12 is a graph indicating a relationship between atomizing processing time and the temperature of the liquid hygroscopic material existing in each of the first region R1 and the second region R2. In FIG. 12, the temperature of the liquid hygroscopic material W existing in the first region R1 is indicated by the solid line, and the temperature of the liquid hygroscopic material W existing in the second region R2 is indicated by the broken line.

As illustrated in FIG. 12, both the temperature of the liquid hygroscopic material W in the first region R1 and the temperature of the liquid hygroscopic material W in the second region R2 increased with progress of the atomizing processing. Upon the effect of heat input from the ultrasonic vibrator 142, the temperature of the liquid hygroscopic material W existing in the first region R1 separated by the heat insulation wall 145 positioned directly above the ultrasonic vibrator 142 rapidly increased immediately after the start of atomizing processing. Although the temperature rise rate was gradual about ten minutes later after the start of atomizing processing, there was a temperature difference of about 10° C. to 15° C. compared with the liquid temperature of the liquid hygroscopic material W in the second region R2 during a period of the atomizing processing.

According to the experiment, it was confirmed that the liquid hygroscopic material W in the first region R1 surrounded by the heat insulation wall was easily affected by heat input from the ultrasonic vibrator 142 and that the temperature thereof efficiently increased.

Although the suitable embodiments according to the invention have been described above with reference to the accompanying drawings, needless to say, the invention is not limited to such examples. It is apparent that a person skilled in the art can conceive of various modifications and alterations within the range of the technical ideas that are described in claims, and of course, such modifications and alterations are understood as falling within the technical scope of the invention.

1. A humidity control system comprising:
a moisture absorption unit that brings a liquid hygroscopic material containing a hygroscopic substance into contact with air and thereby causes the liquid hygroscopic material to absorb at least some moisture contained in the air;
an atomizing and regenerating unit that atomizes at least some moisture contained in the liquid hygroscopic material supplied from the moisture absorption unit, generates atomized droplets, and removes at least some of the atomized droplets from the liquid hygroscopic material to thereby regenerate the liquid hygroscopic material; and
a circulation mechanism that causes the liquid hygroscopic material to circulate between the moisture absorption unit and the atomizing and regenerating unit, wherein
the atomizing and regenerating unit includes
at least one storage tank that stores the liquid hygroscopic material, and
an ultrasonic wave generating unit that is provided at the storage tank and emits ultrasonic waves for generating the atomized droplets to thereby form a liquid column on a liquid surface of the liquid hygroscopic material in the storage tank,
the ultrasonic wave generating unit forms the liquid column on a liquid surface of a first region, which extends in a direction perpendicular to an ultrasonic wave generation surface of the ultrasonic wave generating unit, of the liquid hygroscopic material in the storage tank, and
a flow of the liquid hygroscopic material transported from the moisture absorption unit to the first region in the atomizing and regenerating unit is set in the circulation mechanism to be small relative to a flow of the liquid hygroscopic material supplied from the moisture absorption unit.

2. The humidity control system according to claim 1, wherein
the circulation mechanism includes
a first channel through which the liquid hygroscopic material regenerated by the atomizing and regenerating unit is transported to the moisture absorption unit, and
a second channel through which the liquid hygroscopic material that has absorbed at least some of the moisture contained in the air is transported from the moisture absorption unit to the atomizing and regenerating unit.

3. The humidity control system according to claim 2, wherein
the circulation mechanism includes a third channel through which some of the liquid hygroscopic material in the second channel is returned to the moisture absorption unit, and the third channel has one end side connected to the second channel and has another end side connected directly or indirectly to the moisture absorption unit.

4. The humidity control system according to claim 1, wherein
a temperature of the liquid hygroscopic material in the atomizing and regenerating unit is high relative to a temperature of the liquid hygroscopic material in the moisture absorption unit.

5. The humidity control system according to claim 3, wherein
the other end side of the third channel is connected to the first channel.

6. The humidity control system according to claim 3, wherein
the other end side of the third channel is connected to the moisture absorption unit.

7. The humidity control system according to claim 1, wherein
the atomizing and regenerating unit includes a plurality of the at least one storage tank and ultrasonic wave generating units, the storage tanks each including at least one of the ultrasonic wave generating units, and
the liquid hygroscopic material supplied from the moisture absorption unit is supplied to each of the storage tanks.

8. The humidity control system according to claim 1, further comprising
a control unit that controls a flow of the liquid hygroscopic material transported from the moisture absorption unit to the atomizing and regenerating unit, wherein
the control unit reduces a flow ratio of the liquid hygroscopic material transported to the atomizing and regenerating unit when a concentration of the liquid hygroscopic material increases.

9. The humidity control system according to claim 1, further comprising a heat exchange unit that heats the air, which is supplied to the liquid surface of the liquid hygroscopic material atomized by the ultrasonic wave generating unit, by using the liquid hygroscopic material that is supplied from the moisture absorption unit and has a high temperature.

10. The humidity control system according to claim 1, wherein
the storage tank includes
a heat insulation wall that separates the first region and a second region in which there exists the liquid hygroscopic material whose temperature is low relative to a temperature of the liquid hygroscopic material existing in the first region.

11. The humidity control system according to claim 10, wherein
the heat insulation wall includes a first communication unit through which the first region and the second region communicate with each other.

12. The humidity control system according to claim 10, further comprising a nozzle which is provided in the first region and is used to form the liquid column by the ultrasonic wave generating unit and in which a through hole is formed.

13. The humidity control system according to claim 12, wherein
the nozzle has one end side inserted into the heat insulation wall and has another end side projecting from the heat insulation wall, and the through hole positioned outside the heat insulation wall functions as a second communication unit through which the first region and the second region communicate with each other.

14. The humidity control system according to claim 10, wherein
the heat insulation wall has a functional membrane including a second communication unit through which the first region and the second region communicate with each other and provided facing the ultrasonic wave generating unit, and
the liquid column is formed by the ultrasonic waves being transmitted to the liquid surface via the functional membrane.
